(19) United States
(12) Patent Application Publication
(10) Pub. No.: US 2019/0060972 A1
(43) Pub. Date: Feb. 28, 2019

(54) SYSTEMS FOR ENHANCING FUNCTIONALITY OF INDUSTRIAL PUNCH PRESSES

(71) Applicant: Wilson Tool International Inc., White Bear Lake, MN (US)

(72) Inventor: Anthony David Schwartz, Forest Lake, MN (US)

(21) Appl. No.: 15/685,434

(22) Filed: Aug. 24, 2017

(51) Int. Cl. B21D 28/12; B21D 37/14; B23Q 39/02

(52) U.S. Cl. CPC B21D 28/12; B23Q 2220/002; B23Q 39/02; B21D 37/145

(57) ABSTRACT

Complementary systems are provided for use with industrial punch presses which enhance the functionality of the presses relative to the machining of workpieces. The systems can be adapted to function with certain already-existing structure and operations of the presses, to maximize overall effectiveness and efficiency in using the systems with the presses. Alternately, or in combination, the systems can be linked to one or more functionalities of the punch presses, whereby these functionalities can be used in manipulating the systems when used with the presses.

### FIELD OF THE INVENTION

The present invention generally relates to systems for use with industrial machines or equipment. More particularly, this invention relates to assemblies and methods for use with industrial punch presses to enhance functionality of the presses with respect to fabricating workpieces.

### BACKGROUND

Sheet metal and other workpieces can be fabricated into a wide range of useful products. The underlying fabrication (i.e., manufacturing) processes commonly involve bending, folding, and/or forming holes in the sheet metal and other workpieces. The equipment used for such processes can involve many different types, such as turret presses and other industrial presses (such as single-station presses), Trumpf style machines and other rail type systems, press brakes, sheet feed systems, coil feed systems, and other forms of fabrication equipment adapted for punching or pressing sheet materials.

Punch presses, such as turret or single-station presses, are well known in the art. Typically, these presses are configured to hold a plurality of tools, commonly punches and dies, for forming a variety of shapes and sizes of indentations and/or holes in sheet workpieces, e.g., sheet metal. To that end, when a punch and corresponding die are mounted and located in a working position of the press, e.g., beneath a ram, the punch is driven via the ram to form an indentation or a hole through a sheet workpiece which has been located between the punch and die. Such process is generally repeated with the same or other tool set(s) of the press until machining of the workpiece is completed. Relating to turret presses, during the further machining steps, the workpiece is moved accordingly via pre-programmed direction by the press.

Further to the above, turret presses commonly employ a rotatable upper table or “turret” that carries a plurality of tools (e.g., punches), and a rotatable lower table/turret that carries a plurality of dies. In contrast, single station punch presses generally do not have turrets, but rather have a single station at which the workpieces are machined. For turret presses, when the upper and lower tables are rotated into a position where a particular male punch on the upper table is aligned with a particular female die on the lower table, a workpiece (e.g., a piece of sheet metal) between the two tables can be machined (punched, bent, etc.) by moving the punch downwardly (via the ram) into contact with the workpiece so as to deform (or pierce) the workpiece.

Continuing focus on turret presses, the punch is driven downward when the ram of the press strikes the punch driver, or tool head, of such punch, whereby the opposing end of the tool, or tool tip, is driven forcefully downwardly into contact with a workpiece, which is then deformed (e.g., punched, bent, etc.) between the punch tip and the die. The die commonly has a recess into which the tip of the punch projects during the punching operation. In some cases, a hole is punched in the workpiece during the down stroke of the punch, from which the tip of the punch may shear through the sheet metal (in the process, the tip of the punch extends into the die's central recess). Alternatively, the punching operation can involve other machining of the workpiece, depending on the tool set, such as bending, tapping, etc. of the workpiece.

Based on the above, it should be appreciated that a variety of operations can be performed on a workpiece using punch presses. Particularly, as differing operations are warranted, corresponding tools can be selected for use. Despite this, the functionality of the presses can at times be limited. For instance, while a variety of tools are available for shaping sheet metal, there are other workpiece machining/fabricating operations that would be difficult to perform, even with the tool sets commercially available for such press designs. Alternately, even if the commercially available tool sets available with the punch press could be used for such operations, there may be more effective and/or efficient systems (and processes therefor) by which the same results can be achieved.

The industry has responded accordingly, and as such, there has been an uptick in the design of punch presses configured to accommodate complementary systems capable of providing one or more further functionalities. Unfortunately, these designs have had their drawbacks, including significant increase in overall footprint of the machine, increased complexity in terms of configuration and/or use of the machine (e.g., relating to the differing layouts, functionalities, and procedures of use between the conventional press and the complementary system), and of course, increased cost of the machine. Embodiments of the invention are focused on addressing these and other challenges in providing complementary functionality for punch presses, whereby assemblies and processes of the embodied systems can be more seamlessly adapted with the conventional design and functioning of the presses, while also keeping the footprint of the machine to a minimum.

### SUMMARY OF THE INVENTION

Embodiments of the invention relate to complementary systems for use with industrial punch presses in order to enhance their functionality. The embodiments focus on systems that conduct processes that, if performed, would be of added value for the presses relative to the machining of workpieces. In some cases, embodiments are focused on systems and manners by which they are incorporated to function with the presses. For example, the systems can be adapted to function with certain already-existing structure and operations of the presses, to maximize overall effectiveness and efficiency in using the systems with the presses. Alternately, or in combination, the systems can be linked to one or more functionalities of the punch presses, whereby these functionalities can be used in manipulating the systems when used with the presses. These and other embodiments of the invention are further detailed herein.

In one embodiment, a combination of a punch press and a complementary system is provided, and the system is adapted to perform one or more processes to enhance functionality of the punch press. The combination comprises a punch press and a system. The punch press comprises a table for supporting workpieces for machining with the press and the system, and an outer enclosure being defined with an opening through which the table extends. The table is adapted to selectively move workpieces positioned thereon in a horizontal plane internal and external to the press via the opening. The system comprises a functional assembly including a functional head. The functional head is configured for performing a machining operation on a workpiece. The functional assembly is mounted to the outer enclosure of the press such that the assembly is positioned physically separate from an interior of the punch press and the functional head is limited to vertical movement relative to the outer enclosure and adjacent to the opening, wherein a workspace for the operation on the workpiece by the functional head is defined as lying adjacent to the opening.

In another embodiment, a complementary system for use with a punch press is provided. The system is adapted to perform one or more processes to enhance functionality of the punch press. The system comprises a functional assembly comprising a functional head. The functional head is configured for performing a machining operation on a workpiece. The functional assembly is configured for mounting to an outer enclosure of a punch press such that the assembly is positioned physically separate from an interior of the punch press and the functional head is limited to vertical movement relative to the outer enclosure. The functional assembly further comprises a slide assembly that supports the functional head, wherein movement of the slide assembly corresponds to the vertical movement of the functional head; and a motor assembly configured to operably actuate the sliding assembly. The functional head, the slide assembly, and the motor assembly are in a vertically-stacked configuration so as to establish a tight profile with the press if mounted thereto, whereby the functional assembly extends no more than 2 feet from the outer enclosure.

In a further embodiment, a method is provided for performing one or more operations per a machining work order via both a punch press and a complementary system thereof. The system enhances functionality of the punch press. The method comprises the steps of: providing a system comprising a functional assembly including a functional head, wherein the functional head is configured for performing a machining operation on a workpiece, and the functional assembly is mounted to an outer enclosure of the press such that the functional head is positioned adjacent to an opening defined in the press outer enclosure; inputting a workpiece machining job via a user console; uploading corresponding operations for the job to a control module of the press; performing the operations on a workpiece via the press and the system, one of the operations involving the system whereby the control module directs the workpiece to be positioned beneath the functional head and actuates the functional assembly for the one operation to be performed, whereby the functional head is moved from a stored position to a working position for performing the one operation on the workpiece and the one operation is performed on the workpiece via the functional head in a workspace adjacent to the press enclosure opening.

### BRIEF DESCRIPTION OF THE DRAWINGS

The following drawings are illustrative of particular embodiments of the present invention and therefore do not limit the scope of the invention. The drawings are not necessarily to scale (unless so stated) and are intended for use in conjunction with the explanations in the following detailed description. Embodiments of the invention will hereinafter be described in conjunction with the appended drawings, wherein like numerals denote like elements.

FIG. 1 is a perspective cutaway view of a portion of an upper table of a turret press and a tool assembly thereof in accordance with certain embodiments of the invention;

FIG. 2 is a perspective cutaway view of a further portion of the turret press of FIG. 1, showing various other tool assemblies thereof;

FIG. 3 is a front elevation view of functional assembly of an exemplary system, used with the punch press representative of that shown in FIG. 1, in accordance with certain embodiments of the invention, with the assembly being shown in an inactive position relative to a workpiece;

FIG. 4 is a further front elevation view of the system functional assembly and representative press of FIG. 3, in accordance with certain embodiments of the invention, with the assembly being shown in an active position relative to the workpiece;

FIG. 5 is a perspective partial view of the system functional assembly and representative press as shown in FIG. 4, wherein an enclosure for the assembly is shown in transparent form;

FIGS. 6 and 6A are perspective view of functional assembly of another exemplary system, used with a punch press, and enlarged perspective view of the assembly, respectively, in accordance with certain embodiments of the invention, with the assembly being shown in an inactive position relative to a workpiece;

FIG. 7 is a front perspective view of functional assembly of a further exemplary system, used with the punch press representative of that shown in FIG. 1, in accordance with certain embodiments of the invention, with the assembly being shown in an inactive position relative to a workpiece;

FIG. 8 shows a flowchart for one method of using an exemplary system with a punch press in accordance with certain embodiments of the invention.

FIG. 9 shows a flowchart for another method of using an exemplary system with a punch press in certain embodiments of the invention.

FIG. 10 shows a perspective view of a passive tool assembly used with punch press and configured for wireless communication in accordance with certain embodiments of the invention, with the assembly shown in transparent form.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and other elements employ that which is known to those of ordinary skill in the field of the invention. Those skilled in the art will recognize that many of the noted examples have a variety of suitable alternatives.

Embodiments described herein are focused on enhancing the functionality of punch presses, e.g., conventionally used for punching or bending sheet metal. What is generally meant herein by enhancing functionality is to provide one or more processes not typically associated with such presses, or which perhaps could be performed more effectively/efficiently than with the presses, relative to fabricating/machining workpieces. As noted above, while tooling has been used with punch presses to selectively shape workpieces, there are other known machining/fabricating processes that would be either not applicable or not effectively/efficiently performable with conventional use of such presses. Etching/scribing and cutting are machining operations that have been particularly identified as valuable complementary functions, but there are others as well. Adding further systems and their processes to punch presses has been a challenge, particularly while attempting to limit the footprint and complexity contributed to the overall press design. Certain embodiments described herein focus on a particular system that is incorporated with a punch press. To that end, the embodied system is particularly described in terms of its configuration and functionality. However, it should be understood that embodiments of the invention are also applicable to other complementary systems being used with punch presses, having different functionalities and/or configurations.

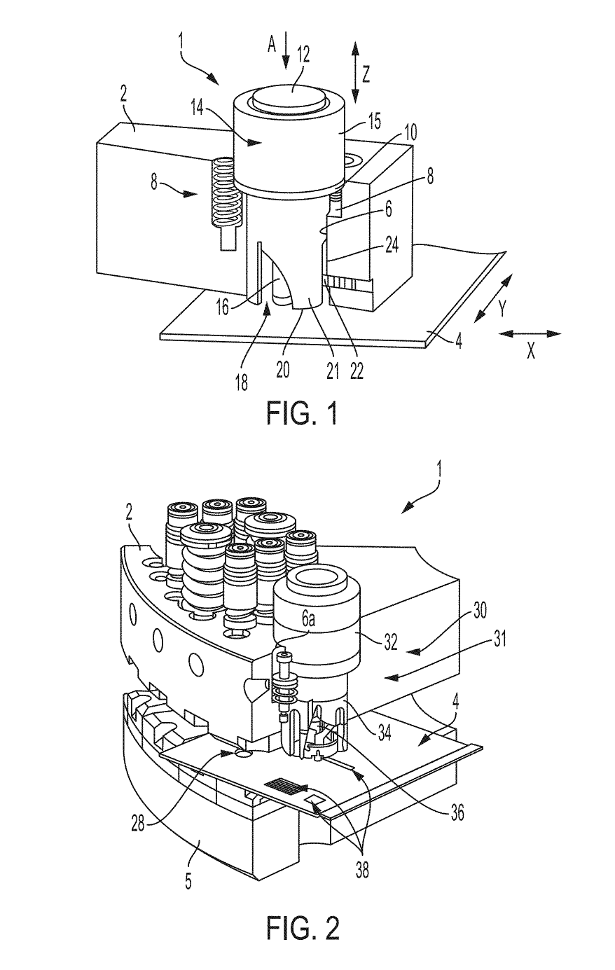

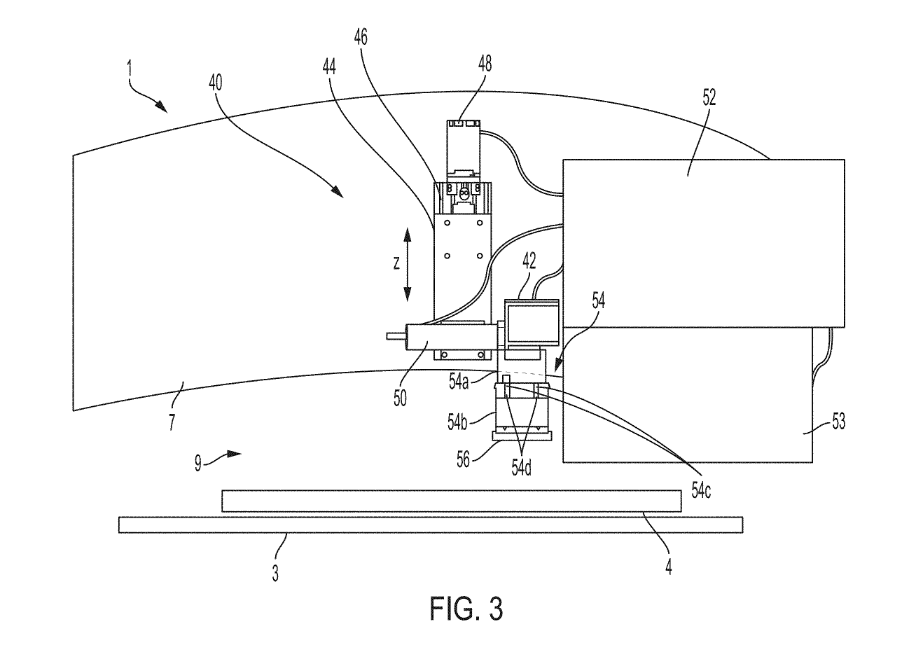

FIG. 1 is a perspective cutaway view of a portion of an upper table 2 of a turret press 1, and a tool assembly 10 loaded therein. As shown, the tool assembly 10 extends through a bore 6 of the turret table 2, and rests on lifter springs 8 mounted within and about a periphery of the bore 6. Those skilled in the art will understand that, although not shown in FIG. 1, an entirety of the upper table 2 includes a plurality of additional bores, either larger or smaller or similar in diameter to the bore 6 (e.g., see FIG. 2), which are arranged about a central axis of upper table 2. Likewise, the skilled artisan will appreciate that the press would further include, among other components, a table 3 (e.g., see FIG. 3) that supports and moves a workpiece 4 in x- and y-directions, a lower table 5 (e.g., see FIG. 2) of the turret that resides below the upper table 2, and a ram or striker (represented in FIG. 1 as arrow A, with arrow further in reference to the ram's operational downward stroke).

Additional bores of the upper table 2 (e.g., bore 6a in FIG. 2), along with the bore 6 shown in FIG. 1, are each adapted to accommodate a tool assembly. Conventional tool assemblies generally involve a punch portion being accommodated by the upper turret, and a die portion accommodated by the lower turret. This common configuration of tool assembly, however, may be varied with respect to certain embodiments of the invention, as described later. As already described, for conventional operation of the press 1, when any of the bores of the upper turret are located beneath the ram A of the press 1, such as with reference to the assembly 10 of FIG. 1, the ram A would be configured to strike a head 12 (e.g., of a first portion 14) of the assembly 10 so as to drive the assembly 10 downward. In turn, during further machining of the workpiece 4, the press table 3 (see FIG. 3) would be moved in pre-programmed fashion to correspondingly move the workpiece 4, so as to continue machining of the workpiece with the same or other of the press's tool sets, e.g., see FIG. 2, exemplifying the upper turret 2 with plurality of punch assemblies.

FIGS. 3-5 show a functional assembly 40 of one exemplary system for use with the press 1 of FIGS. 1 and 2 in accordance with certain embodiments of the invention. While use of the system is herein described with respect to such turret press 1, with corresponding advantages being noted therefor, the invention is also applicable to other ram-driven punch presses. For example, such other presses can include single station presses, such as the Durma, RP6 or RP9, punching machine, and the Privatec platen machine, which are known to those skilled in the art. To that end, while different positions and/or views of the functional assembly 40 are illustrated in FIGS. 3-5, for sake of clarity, the press 1 is shown in partial block form.

Beginning with FIG. 3, it shows the functional assembly 40 with functional head 42 at one position (inactive or stored setting) relative to the punch press 1 and the workpiece 4. The portion of the press 1 exemplarily shown is part of an outer enclosure 7 for the press 1. Based on the particular design of the press 1, the outer enclosure 7 can take the form of any combination of outer frame members and walls. In any case, it should be appreciated that, in certain embodiments, at least the functional assembly 40 is provided external to the press 1. Establishing a set position for the functional assembly 40 (and most notably, the functional head 42 thereof) relative to the press 1 (and in turn the workpiece 4) is crucial in order for corresponding operations on the workpiece 4 to be precise and accurate. To that end, in certain embodiments, at least the functional assembly 40 is mounted to the outer enclosure 7 of the press 1. In such case, the outer enclosure 7 is defined with an access opening 9, through which the workpiece 4 can be traversed by the press table 3 in x- and y-directions below the assembly 40 (and functional head 42 thereof), according to the desired machining operations. Thus, embodiments of the invention are applicable to any complementary system being provided with punch press, provided the functional assembly therefor is situated external to the press.

What should be initially appreciated from situating the assembly 40 external to the press 1 is that certain complexity involved with the system's integration can be averted. For example, if the functional assembly 40 was to be configured to lie internal to the press 1, the skilled artisan would appreciate the significant design alterations involved (and potential interference) with the press' normal configuration and functioning. For example, the different functionality of the system and underlying mechanisms (for powering as well as for providing such functionality) would complicate and correspondingly increase the size of the interior of the press 1. To that end, situating the functional assembly 40 separate from (e.g., on the exterior of) the press 1 corresponds with fewer complications for the combination, although, as already described, such configuration would warrant a thoroughfare (e.g., the opening 9) for access to the functional assembly 40, such that the workpiece 4 can be readily passed outside the press 1 (via the press table 3) and beneath the functional head 40 for machining thereof.

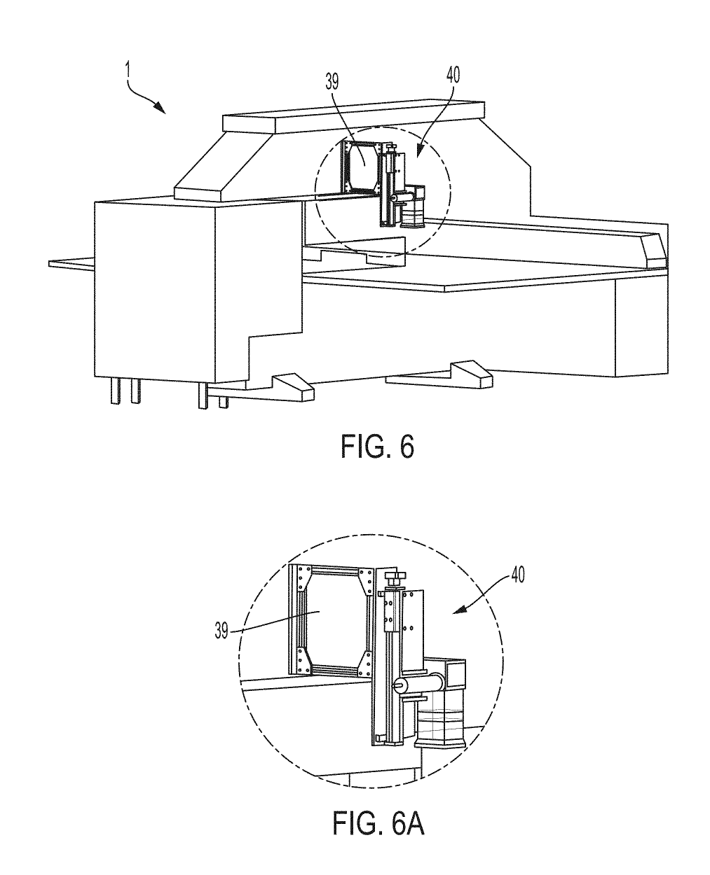

While one mounting configuration can involve the functional assembly 40 being directly mounted to the external structure (e.g., outer wall, framework, etc.) of the press 1, the invention should not be limited to such. For example, in certain embodiments with reference to FIGS. 6 and 6A, the functional assembly 40 (and corresponding system) can be independently configured with an independent fixture mounting 39. As should be appreciated, such a configuration would further enable stable positioning of the functional assembly 40 relative to the press 1 (similar to the case in which the assembly 40 is mounted directly to the press 1), yet further permits more flexibility for positioning of the assembly 40 as is warranted so as to function with differing press types/configurations (i.e., for retrofitting purposes). To that end, in certain embodiments, not the functional assembly 40 but the fixture mounting 39 can be configured for being mounted to the press 1. Thus, the mounting 41 can function as intermediary in mounting the functional assembly 40 to the press outer enclosure 7, while also enabling certain flexibility in the positioning of the assembly 40 (and the functional head 42 thereof) via differing sizes and shapes of the fixtures mounting 39. To that end, while FIG. 6A shows the mounting 39 to be in the shape of a rectangular body (e.g., formed of aluminum), it should be appreciated that the body 39 can be shaped as warranted, so long as the body is sufficiently rigid to support the assembly 40.

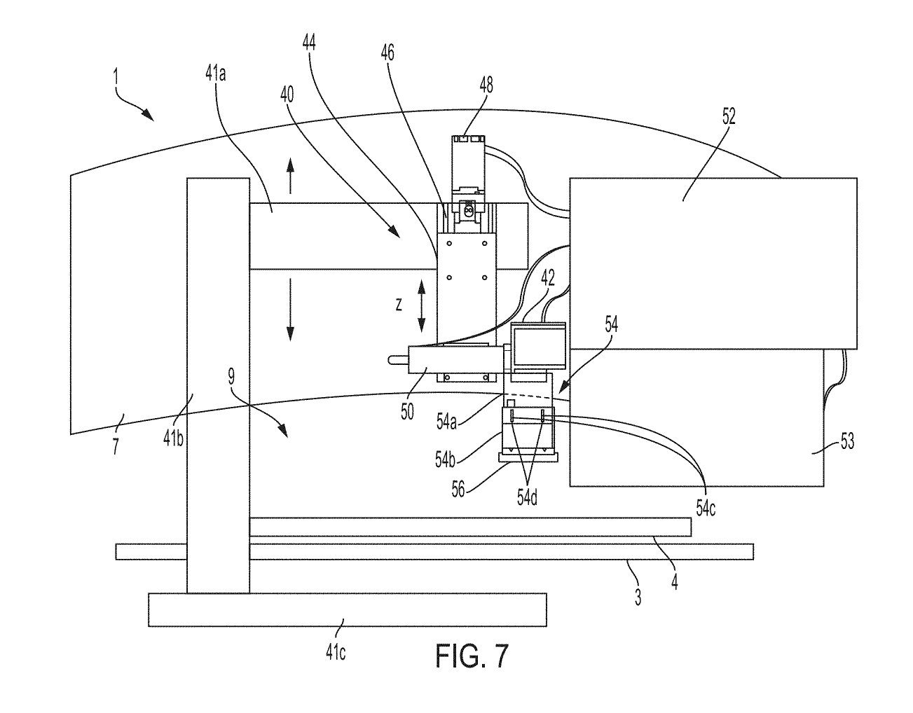

In addition, while mounting configurations can involve the functional assembly 40 being directly (or indirectly) mounted to the external structure of the press 1, the invention is also applicable to a stand-alone configuration. For example, in certain embodiments with reference to FIG. 7, the functional assembly 40 (and corresponding system) can be independently configured with its own station 41. As should be appreciated, such a configuration would continue to enable stable positioning of the functional assembly 40 relative to the press 1 via its mounting to the station 41 (e.g., to an upper portion 41a thereof). However, the station 41 can also permit the set-up positioning of the functional assembly 40 (and functional head 42 thereof) to be selectively varied (both horizontally and vertically) with regard to a designated operation work space for differing press types (i.e., for retrofitting purposes). In certain embodiments, the vertical station 41b of the station 41 would permit the upper portion 41a to be vertically adjustable, while the functional assembly 40 can be further moved (toward and away from the machine) via lower portion 41c thereof (with only an upper segment of such being depicted in FIG. 7), which would extend to the floor and in certain embodiments, be equipped with wheels.

It should be appreciated that other externally-situated configurations could alternately be used in fixing the x-y positioning of the functional assembly 40 (via mounting) in close proximity to the press 1, and thus would be further applicable to the embodiments exemplified herein. However, what should also be appreciated with these mounting configurations is that the positioning, and corresponding limitation as to vertical movement of the functional assembly 40 (and the functional head 42 thereof), mirrors that of tool assemblies used within the press 1. Particularly, with the functional assembly 40 being mounted in close proximity to the press 1 (whether being mounted directly or indirectly to the press 1, or independently via a station 41), the functional head 42 would be limited to vertical movement (in z-directions), while the workpiece 4 is traversed in the x- and y-directions relative to the head 42 via the press table 3. To that end, not only is some of the complexity in using the system with the press 1 averted (e.g., by limiting the vertical head 42 to manipulation along a vertical axis), but such use is made more efficient and effective, as the same workpiece traversing process conventionally used by the press 1 is similarly applicable to the warranted operations of the head 42.

With further reference to FIGS. 3-5 (and as noted above), in certain embodiments, only a portion of the exemplary complementary system is mounted to an exterior of the press 1, notably the functional assembly 40, which includes the functional head 42. Other components of the system include drivers, some of which are case specific based on operating nature of the functional head 42. Under the category of drivers generally applicable to various types of complementary systems, there are corresponding mechanisms provided for enabling the vertical movement of the functional head 42 and its operation. For example, in certain embodiments as shown, a slide assembly 44 is provided, with the slide assembly 44 being vertically traversable (along z-axis) and with the functional head 42 being mounted therefrom. In certain embodiments, the sliding assembly 46 is mounted to the press 1, and the remaining components of the functional assembly 40, such as the functional head 42, are supported and moved by movement of the assembly 46. In certain embodiments, movement of the slide assembly 44 is pneumatically controlled via piston assembly 46, which can be further driven via motor assembly 48; however, other means for facilitating vertical movement of the head 42 and powering the same are just as applicable.

On the other hand, with regard to being case specific based on the functional head 42, there can be corresponding mechanisms for driving the head 42. In certain embodiments, the functional head 42 is a laser head, as will be further detailed herein. In such case, the functional assembly 40 includes an input driver 50, shown extending from the functional head 42, so as to provide the needed input (e.g., power) for operation of the head 42. To that end, in certain embodiments, a control module 52 (depicted in block form) is electrically connected to actuate the motor assembly 48 (to position the functional head 42 accordingly via slide assembly 44) and to actuate the input driver 50 (to regulate desired output of the functional head 42 for its warranted operation). Such control module 52, in certain embodiments, can be tied to an operator console 53, e.g., computer, from which the user can enter (e.g., via keyboard) the desired machining programs. In using the turret press 1, such operator console 53, in certain embodiments, can be used in similar manner in initiating both operations by the press 1 and the functional head 42 of the assembly 40. Again, such universality is attributable to the workpiece traversing process (conventionally used by the turret press 1) being similarly applicable for the warranted operations of the functional head 42 of the system.

As previously noted, a number of punch presses configured with complementary systems have in recent years been introduced to the marketplace. Many of these machines are configured with an enclosure for the complementary system which significantly increases the overall footprint of the machine. In many cases, the overall design of the enclosure (e.g., size) is largely based on the corresponding functionality of such complementary system, which similarly applies to the configurations embodied herein. To that end, an enclosure can be further provided to house one or more of the functional head 42, the functional assembly 40, and other components of the corresponding system, again depending on the machining operations to be provided by the functional head 42. For example, with the functional head 42 taking form of a laser head used for etching/scribing workpieces, an enclosure of relatively small scale can be used therewith for shielding purposes.

Other complementary systems of the invention may dictate use of a more enhanced enclosure. For example, when using laser technology for cutting operations, waste and fumes are generated, which need to be contained and exhausted, respectively. While not depicted, the enclosure for such machining operations would, in certain embodiments, dictate a catch bin (e.g., below the functional assembly of such alternate system) and/or an exhaust hood (e.g., above or below the assembly). To that end, the spacing with regard to the corresponding functional assembly (and its head and workspace for cutting operation on a workpiece) would not significantly vary from that described herein. In some cases, the operations of the functional head 42 may warrant even more shielding, and, consequently, an even-further enhanced enclosure, e.g., with outer walls being provided (alternately or in combination with catch bin and/or exhaust hood) to surround the functional assembly 40 from top and sides to further isolate the assembly 4.

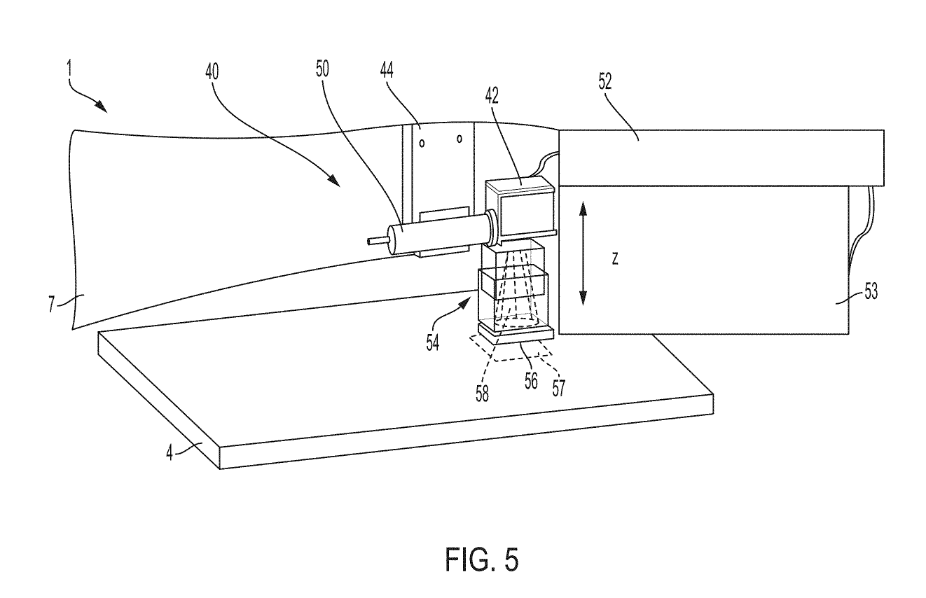

However, regardless of the protective parameters that may be warranted for such enclosure, because the assembly 40 is configured for being positioned in close proximity to the press outer enclosure 7 (direct mounting or indirect mounting, e.g., via station), the overall size and corresponding footprint of the machine can continue to be kept to a minimum. With an external mounting to the press 1, the functional assembly 40 and its functional head 42 are intended to be positioned adjacent to the press outer enclosure 7 and its opening 9. To that end, in certain embodiments as shown, the sliding assembly 44 and the motor assembly 48 are configured to be vertically aligned to keep a tight, close profile for the functional assembly 40. Additionally, in certain embodiments, the functional head 42 and the input driver 50 are oriented collectively to extend substantially parallel to the outer enclosure 7 of the press 1. With keeping such tight, close profile to the press 1, it should be understood that a corresponding workspace 57 (see FIG. 5) for operations performed by the functional head 42 is set to similarly lie adjacent to the press outer enclosure 7 and its opening 9. To that end, in certain embodiments, the functional assembly 40 (including the functional head 42 and the workspace 57 defined therefor), in certain embodiments, extends no more than 2 feet from the press outer enclosure 7. In more preferable embodiments, the functional assembly 40 (including the functional head 42 and the workspace 57 defined therefor) extends no more than 1.5 feet from the press outer enclosure 7. In particularly preferable embodiments, the functional assembly 40 (including the functional head 42 and the workspace 57 defined therefor) extends no more than 1 foot from the press outer enclosure 7.

Continuing with the above-described theme, by positioning the functional assembly 42 on the exterior of the press 1 (via direct or indirect mounting), in certain embodiments, the functional head 42 thereof is positioned to align with a vertical axis of the press ram A, so as to minimize the amount of offset from such ram. To that end, for machining work jobs, in which a workpiece 4 is transferred via support table from inside the press 1, the time required to traverse the workpiece 4 to the workspace 57 beneath the functional head 42 is minimized (requiring movement of the workpiece 4 only in one direction along a single axis). In certain embodiments, for example, the functional head 42 has a zero y-axis offset from a down stroke axis of the ram A, and x-axis offset from same of no more than 4 feet. In more preferable embodiments, the functional head 42 has a zero y-axis offset from the down stroke axis of the ram A, and x-axis offset from same of no more than 3.5 feet. In particularly preferable embodiments, the functional head 42 has a zero y-axis offset from the down stroke axis of the ram A, and x-axis offset from same of no more than 3 feet.

Shifting back to FIGS. 3-5 (and as already noted), in certain embodiments, the functional head 42 can be a laser head used for etching/scribing workpieces, and the enclosure exemplarily shown for such involves a shroud 54. The shroud 54 is shown to shield the output area of the functional head 42, while defining an opening at the shroud's lower end 56 for warranted operations on the workpiece 4. Thus, while blocking exposure from top and sides, the shroud 54 seals off the surrounding environment during the etching/scribing operations, which is warranted based on the high wavelength, e.g., 1064 nm, requisite for such operations. In such case, for example, the shroud 54 can be formed of a material, such as laser safety viewing glass, commercially available from any of a variety of companies (e.g., Laser Safety Industries of Minneapolis, Minn.), to filter out the high wavelengths of the laser, while permitting the operator to see the operation inside the shroud 54. However, the design of the shroud 54 should not be so limited, as it could be formed of a metal (e.g., aluminum) enclosure, although such a metal design would not permit operator viewing.

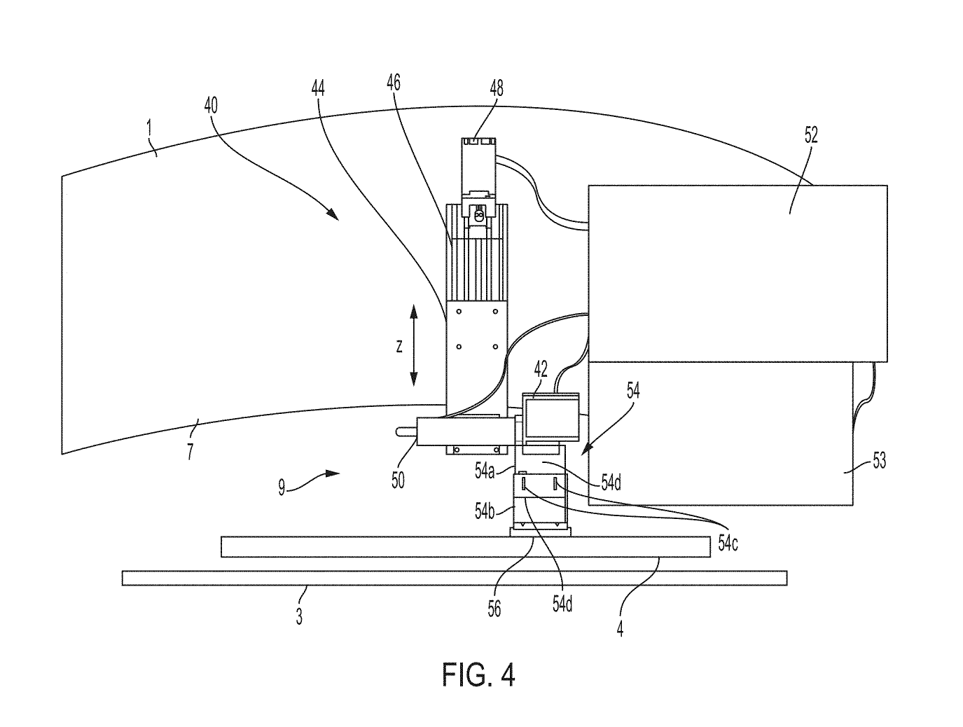

As described above, FIG. 3 shows the functional assembly 40 in an inactive (or stored) position relative to the workpiece 4. As such, there is a gap shown between the workpiece 4 and the functional head 42 (and shield 54 thereof, as applicable in this example). By way of comparison, FIGS. 4 and 5 illustrate the functional assembly 40 in an active (or working) position relative to the workpiece 4, whereby the functional head 42 is lowered toward the workpiece 4 so as to perform the warranted operation(s) thereon. The shroud 54 is exemplarily shown as being brought in contact with the workpiece 4, with the functional head 42 exemplarily shown (in FIGS. 4 and 5) at a distance from the workpiece 4 in performing its operation. What should be at least be ascertained from the depictions in FIGS. 4 and 5 is not only the distance or gap between the head 42 and the workpiece 4 that may be warranted when performing an operation, but the corresponding functioning of the shroud 54 with respect to containment of the system's process. To that end, in certain embodiments, such shroud 54 or like structure can be sufficient for containment of the process, negating the need for additional structure, and keeping the overall footprint of the press 1 to a minimum.

It should be appreciated that if the functional head 42 needs to make contact or vary its spacing from the workpiece 4 for machining, the shroud 54 can be of reduced size or of automatic height-reducing configuration so as to permit the head 42 to extend to or beyond the shroud opening 56 during operation(s) on the workpiece 4. For example, in certain embodiments as shown, the shroud 54 is shown to include an upper portion 54a and a lower portion 54b configured to slide around and relative to the upper portion 54a. While it is feasible for the upper portion 54a to instead be larger in size, i.e., to slide around and relative to the lower portion 54b, it would generally be preferable to have the portion with the larger-sized opening nearest the workpiece 4 for the intended operations (e.g., to maximize machining area). In either case, pins 54c are exemplarily used in joining the portions 54a and 54b, while vertical slots 54d are defined in one of the portions 54a, 54b (with holes, not shown, provided in the other portion). In use (and with reference to FIGS. 3 and 4), when the lower portion 54b contacts the workpiece, the upper portion 54a is permitted to continue its downward descent (relative to the lower portion 54b) to the desired operating position, up until the pins 54c contact the lower ends of the slots 54c. Then, upon the functional head 42 being raised to its inactive position, the upper portion 54a will lift relative to the lower portion 54b until pins 54c contact the upper ends of the slots 54c, after which the upper and lower portions 54a, 54b will move (rise away from the workpiece 4) collectively.

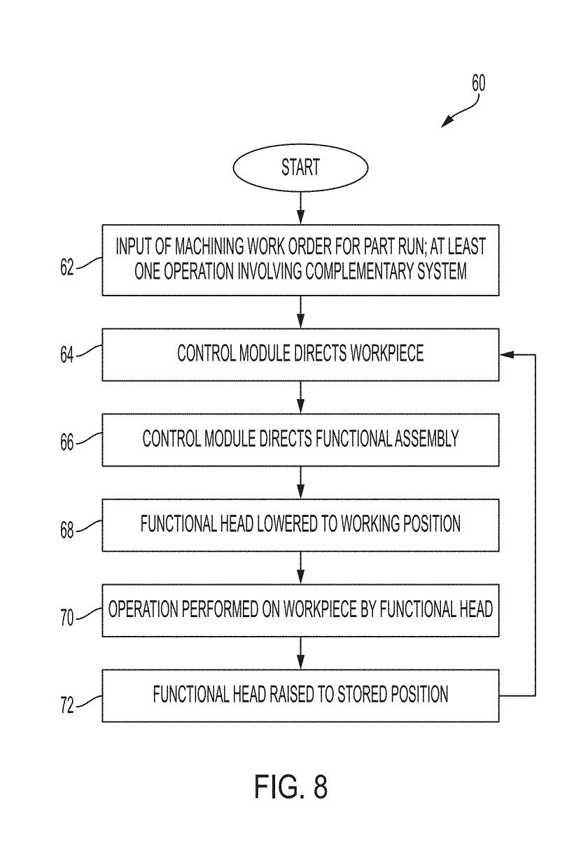

FIG. 8 shows a flowchart 60 for an exemplary method of using an external system with a punch press in certain embodiments of the invention, with reference to FIGS. 3 and 4. Step 62 of the flowchart begins with an inputting of a machining work order for a particular part run. To that end, the machine job involves a series of operations, at least one of which is performed by a tool set of the press 1 and at least one of which is performed via the complementary system. When the operation for the complementary system is needed, the control module 52 triggers the press' support table 3 in step 64 to correspondingly position the workpiece 4 beneath the functional head 42 for the operation. In step 66, the control module 52 directs the functional assembly 40, again based on the machine operation. This involves actuating the motor assembly 48 to correspondingly move the slide assembly 44. Step 68 involves the functional head 42 of being lowered from stored position to working position relative to the workpiece 4, and step 70 involves the functional head 42 conducting the operation on the workpiece 4. As described above, this operation can be regulated via the control module 52, e.g., sending signal to the input driver as pre-programmed for the functional head's operation. Following completion of the operation on the workpiece 4, Step 72 involves raising the functional head 42 back to its stored position via input from the control module 52. The process is then looped back to step 62 for a next part job, and corresponding operation, to be input.

Focus is now centered on the system exemplarily depicted with the press 1, and particularly, its functional head 42. As described above, embodiments of the invention are applicable to any complementary system being provided with a punch press, provided the functional assembly therefor is situated external to the press. To that end, in certain embodiments, the functional head 42 can take the form of a laser head used for etching/scribing purposes. As a backdrop, the use of lasers has become quite prominent in recent years in the metal processing industry, particularly for etching/scribing and cutting operations. However, while efficient for these functions, lasers are otherwise quite limited for other metal processing. For example, lasers used for cutting operations only can provide for two-dimensional cutting, whereas punch presses can be used to not only produce holes in sheet metal but also perform secondary operations, such as forming or tapping of the metal. Thus, the marriage of punch press and a laser system, for example, would be of great value in providing an all-inclusive machine for the manufacturer. Although, as noted herein, the complementary system, in certain embodiments, can also be adapted for retrofitting purposes, whereby the functional assembly 40 can be separately provided (e.g., configured on its own station) and readily adapted with existing punch press machines.

Differing laser types can be used for sheet metal machining depending on the warranted operations. For example, for etching/scribing and cutting operations, fiber laser assemblies are commercially available from a number of manufacturers, such as SIC Marking of Pittsburgh, Pennsylvania, with laser sources used therewith being commercially available from a further number of manufacturers, such as IPG Photonics, headquartered in Oxford, Mass. To that end, the laser assemblies and sources thereof can be readily furnished as is desired, for the herein-described laser embodiments. Regarding fiber lasers, they have been found to be a popular industry choice based on their generally lower power consumption and low maintenance, as compared to other laser types. To that end, parameters for a fiber laser system are further detailed herein; however, it should be appreciated that systems employing other lasers types are just as applicable to embodiments of the invention. Cutting and etching operations warrant differently-sized fiber lasers, whereby such lasers used for etching are configured for significantly lower wattage (e.g., generally being 10 w, 20 w, or 50 w) than those used for cutting (e.g., generally being 500 w, 1000 w, 2000 w, 4000 w, or even higher wattages). Depending on the warranted functionality for the punch press, the elements of the laser system can be accordingly sized, and then configured for such complementary system to be used with the punch press 1.

To this point, embodiments described herein have involved complementary systems being incorporated external to punch press machines so as to not impact the internal configuration and functioning of the press. Further, functional assemblies, and correspondingly, functional heads of such complementary systems have been embodied for being mounted (directly or indirectly) to the exterior of the press so as to minimize the overall footprint of the machine. Such mounting further regulates the functional head to be limited to vertical movement, so as to mirror the positioning/movement of punch assemblies of the press. As a consequence, and particularly with respect to a punch press that uses a support table for moving the workpiece during machining (such as with turret presses), the corresponding workpiece-traversing system conventionally used with the punch assemblies of the press can be similarly used for operations of the functional head of complementary system.

The above-noted similarity relating to the press' and system's operations further permits machining work orders to blend operations, while also enabling such work orders to be entered at a single operator console. As described above, a control module is used to receive instructions from the operator console and subsequently trigger the warranted operations. To that end, in certain embodiments, the input work codes for operations to be conducted by the complementary system (which could also be part of a series of machining operations for the press, collectively provided in an input work order) can be thought of as one or more bits of information as to how the functional assembly 40 is to be directed (and with turret presses, how the workpiece 4 should be correspondingly traversed via the support table for such operation). The extent of such direction is largely dependent on the operations performable by the functional head 42. For example, if the operations may vary in terms of height of the functional head 42 from the workpiece 4 and magnitude of output from the head 42, these variables would be linked to the bits of information (provided via the work codes) received by the control module 52 (in addition to the actual specifics of the operation that is to be performed, given such height from workpiece 4 and output magnitude), by which the module 52 would direct the motor assembly 48 and functional head 42, respectively. However, in certain embodiments, such direction provided to the control module 52 can stem from the functionality of the press 1, as further described below.

Shifting back to FIGS. 1 and 2, in certain embodiments, one or more of the tool assemblies of the turret press 1 (e.g., the tool assembly 10 of FIG. 1) can take the form of a ‘passive’ tool, rather than an ‘active’ tool as those typically found within other bores of a press 1. The term ‘passive’ is used herein to refer to a tool that does not itself perform a function on a workpiece, yet as a result of its movement (via response to a ram stroke of the press), corresponding action is triggered for the complementary system used with the press 1. To that end, while continuing focus on enhancing functionality of the press 1 via inclusion of the complementary system, the triggering and manipulation of such system, in certain embodiments, can be tied to use of one of the ‘passive’ tools of the press and its movement, brought on by the down stroke of the ram.

Continuing with reference to FIG. 1, via a cut-away portion of lower housing 21 of the tool assembly 10, a body 16 can be seen within the assembly's bore 18. Such body would conventionally involve a punch, oriented to perform a function on the workpiece as it is driven from the bore of the turret table 2. In other designs, the tool may not involve a punch, but instead a functional head intended for other than punching. For example, FIG. 2 shows a tool assembly 30 having a printing head 36, and thus can be considered a marking tool 31, while further-shown tool assemblies of the turret press 1 are of the punch tool variety. The printing functional head 36 is configured to function in a ‘direct’ manner on the workpiece 4 (with respect to providing one or more printed features 38 thereon), and as such is similar to the ‘direct’ functioning of other punch tool assemblies. Particularly, in direct response to the down stroke of the ram on upper portions of these tool assembly configurations, each is configured to perform an operation on the workpiece 4.

Shifting back to the tool assembly 10 of FIG. 1, the body 16 thereof is configured in certain embodiments to function in an ‘indirect’ manner relative to the workpiece 4. For example, the body 16 can take the form of a sensor, whereby its movement via downward stroke of the ram A, can be used to trigger and optionally direct the complementary system accordingly. To that end, while shown within the assembly 10, the body 16 could just as well be provided on (or recessed within) an exterior (e.g., an outer surface) of the assembly 10. Again, the body 16, regardless of its positioning relative to the tool assembly 10, is not configured to perform an operation on the workpiece 4 when moved downward (via down stroke of the ram A). Instead, via movement of the assembly 10, and the body 16 thereof, the complementary system used with the press 1 can be directed relative to its intended operation on the workpiece 4.

For example, in certain embodiments, upon selection of the tool assembly 10 (i.e., being loaded in the upper turret 2 of the press 1 and subsequently selected for alignment with the ram A) subsequent movement of the assembly 10 (and most notably, the body 16 thereof) via downward stroke of the ram A can translate to the extent of movement of the head 42 (i.e., toward the workpiece 4) for the intended machining operation. In this manner, a variable parameter (e.g., distance between functional head 42 and workpiece 4) of the operations conducted can be easily varied as part of the normal functioning of the press. In certain embodiments, the body 16 can be a variable sensing device, such as a linear potentiometer. To that end, extent of movement of the tool assembly 10, and more notably, the body 16 (brought on by down stroke of the press ram A), can be measured via the device and translated for corresponding movement of the system's functional head 42 relative to the workpiece 4 for the operation. In the case of a potentiometer, vertical movement of the body 16 (when the tool assembly 10 is impacted by the press ram A) prompts a corresponding signal to be transmitted via corresponding circuitry to the control module 52, which correspondingly directs the slide assembly 44 to bring the functional head 42 to a corresponding distance toward the workpiece 4.

It should be appreciated that the above system offers significant versatility for the complementary system, depending on the variability of the operations conducted by the functional head 42. For example, as previously described, via use of the operator console 53, a plurality of work codes can be assigned to correspond to applicable operations for the functional head 42. However, with each of these operations, there can be a further applicable wide range of distances between the head 42 and workpiece 4 to perform the operation. The skilled artisan would appreciate the onerous task in compiling such a matrix of work codes for every applicable distance from the workpiece 4 for which the functional head 42 may foreseeably be needed to perform such operation, not to mention the potential that the operations may call for change in such distance during same operations. Thus, provided the downward stroke length of the ram A can be varied for the press 1, such tool assembly 10 (and its body 16) could facilitate warranted positioning of the functional head 42 for each of its intended operations.

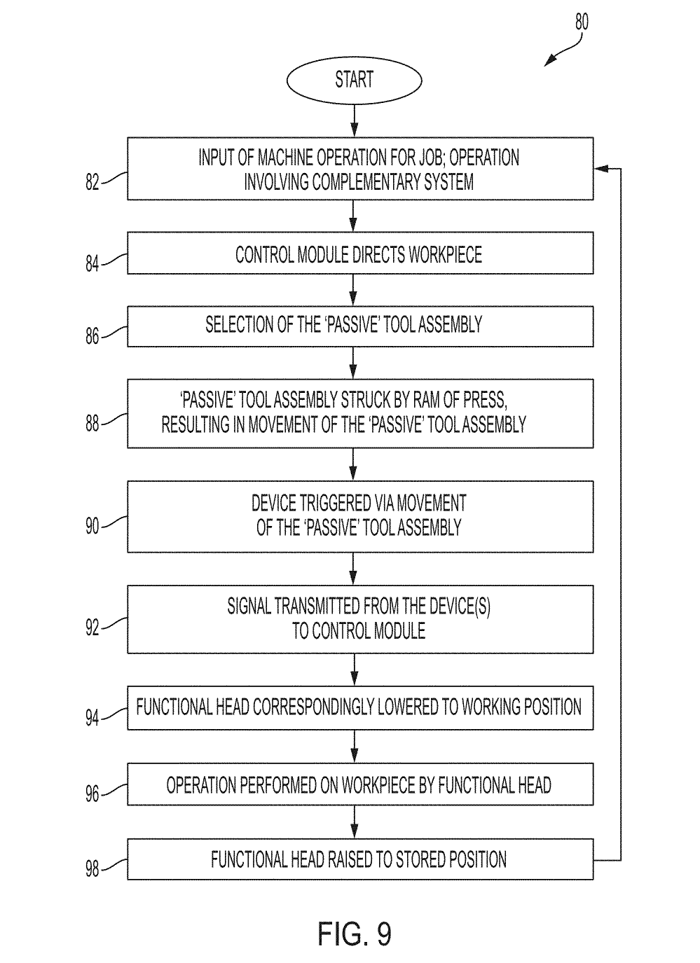

FIG. 9 shows a flowchart 80 for another method of using an external system with a punch press in certain embodiments of the invention. The method is provided for a 1:1 ratio of ‘passive’ tool assembly 10 to external system, with reference to FIGS. 1, 3, and 4. Step 82 of the flowchart begins with an inputting of a machining operation for a particular part run. To that end, the operations, in certain embodiments, are input via operator console 53, and then uploaded to control module 52 for the press 1. Based on the operation, in step 84, the control module 52 triggers the press' support table 3 to correspondingly position the workpiece 4 beneath the functional head 42 for the operation. Step 86 involves selection of the ‘passive’ tool assembly 10 of the press 1 for alignment with the press ram A, while step 88 involves downward stroke of the ram A on the striking surface 12 of the assembly 10, whereby the ram stroke corresponds to downward movement of the tool assembly 10 within the turret bore 6.

Such movement of the tool assembly 10 triggers a device used as the body 16 with the assembly 10 in step 90, whereby a signal is transmitted from the device to the control module 52 based on distance moved by the device. Step 94 involves the functional assembly 40 of the external system being lowered from stored position to working position relative to the workpiece 4. As described above, such lowering can be derived from the signal received by the control module 52 from the device. Step 96 involves the functional head 42 conducting the operation on the workpiece 4. As described above, this can be regulated via the control module 52, e.g., sending signal to the input driver 50 as pre-programmed for the functional head's operation. Following completion of the operation on the workpiece 4, step 98 involves raising the functional head 42 back to its stored position via the control module 52. The process is then looped back to step 82 for a next part job, and corresponding operation, to be input.

Further to the above, certain embodiments have been herein described with respect to use of a single complementary system; however, the invention should not be limited to such. Particularly given some of the parameters of the embodiments (e.g., mounting, directly or indirectly, the functional assembly to the exterior of the press 1), adding one or more further complementary systems, each with differing functional heads, would be applicable while continuing to keep the footprint of the machine to a minimum. To that end, and relating to the described embodiments involving a ‘passive’ tool assembly 10, instead of using a 1:1 ratio for such tool assembly to complementary system, the applicable ratio could be 1:N or N:N, with N being greater than 1.

With such configurations, functionality of the press 1 can thereby be enhanced by a factor of N, with reference to many of same concepts heretofore described.

For example, regarding a turret press configured for a 2:2 ratio, the two ‘passive’ tool assemblies (e.g., each of similar design to the assembly 10 of FIG. 1) would be positioned in corresponding bores of the upper turret, and then during machining operations, the assemblies would be selected as pre-programmed. Regarding the two external systems, their functional assemblies (e.g., each of similar design to the assembly 40 of FIGS. 3 and 4), in certain embodiments, can be mounted side-by-side on an external wall of the press, so as to be accessible via the workpiece support table of the press. To that end, upon selecting either of the ‘passive’ tool assemblies for alignment with and subsequent striking by the press ram, a signal from the corresponding body thereof would be transmitted to the corresponding complementary system via the control module for positioning of the functional head (corresponding to the selected tool assembly) for the intended operation. Alternatively, given a 1:2 ratio and an operation programmed for either of the two complementary systems, the corresponding functional head of the system would be positioned based on the movement (via ram strike) of said one tool assembly, again via the control module 52 functioning as intermediary in the process.

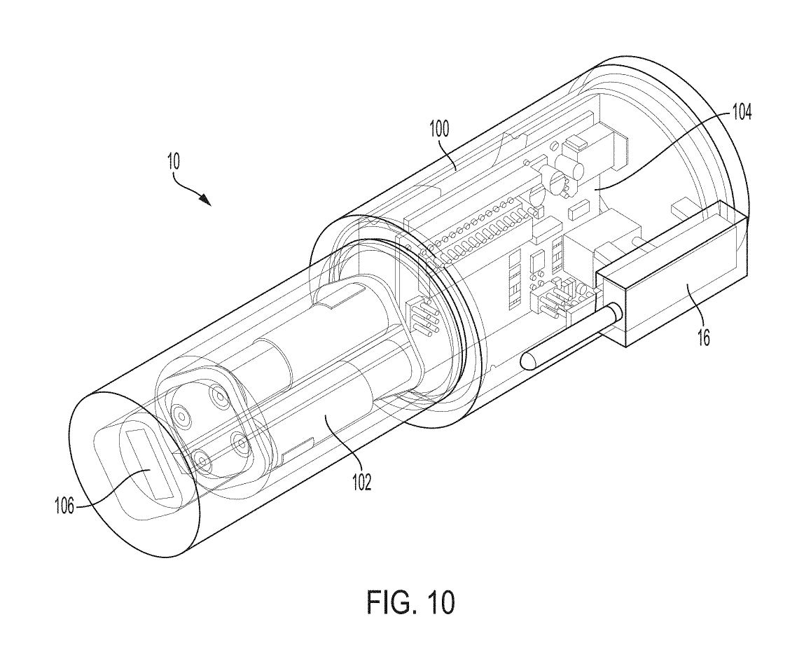

To this point, transmittance of signal(s) has been described from the body 16 of the tool assembly 10 to the control module 52. Such transmittance can be provided in a number of ways. While certain embodiments can involve direct wiring being provided between the tool assembly 10 and the control module 52, the invention should not be limited to such. For example, in certain embodiments with reference to FIG. 10, the transmittance could be made via a wireless network (e.g., Bluetooth network), with wireless transmitter 100 used with the tool assembly 10 (e.g., situated therein). To that end, underlying circuitry for such wireless configuration would warrant a power source 102, e.g., one or more batteries, and microcontroller circuit 104 to receive output from the device 16, e.g., potentiometer, and transmit corresponding signal via transmitter 100 to control module 52 (e.g., to wireless receiver used therewith). To limit drain on the power source 102, a switch 106 can be connected thereto. In configurations configured for an N:N ratio of ‘passive’ tool assemblies to external systems (with N being greater than 1), the wireless transmittance for each tool assembly/complementary system pairing, in certain embodiments, could be provided over a differing frequency.

Thus, embodiments of SYSTEMS FOR ENHANCING FUNCTIONALITY OF INDUSTRIAL PRESSES are disclosed. One skilled in the art will appreciate that the invention can be practiced with embodiments other than those disclosed. The disclosed embodiments are presented for purposes of illustration and not limitation, and the invention is limited only by the claims that follow.

What is claimed is:

1. A combination of a punch press and a complementary system, the system adapted to perform one or more processes to enhance functionality of the punch press, the combination comprising:
a punch press that comprises:
a table for supporting workpieces for machining with the press and the system; and
an outer enclosure being defined with an opening through which the table extends, the table being adapted to selectively move workpieces positioned thereon in a horizontal plane internal and external to the press via the opening;
and a system comprising a functional assembly including a functional head, the functional head configured for performing a machining operation on a workpiece, the functional assembly being mounted to the outer enclosure of the press such that the assembly is positioned physically separate from an interior of the punch press and the functional head is limited to vertical movement relative to the outer enclosure and adjacent to the opening;
wherein a workspace for the operation on the workpiece by the functional head is defined as lying adjacent to the opening.

2. The combination of claim 1 wherein the functional assembly includes a slide assembly, the slide assembly being mounted to the press outer enclosure and supporting the functional head, wherein movement of the slide assembly corresponds to the vertical movement of the functional head.

3. The combination of claim 2 wherein the outer enclosure of the press comprises a plurality of frame members, wherein the slide assembly is mounted to one or more of the frame members.

4. The combination of claim 2 wherein the slide assembly is pneumatically controlled via a piston assembly that is operably connected to a motor assembly for actuation.

5. The combination of claim 1 wherein the functional assembly further comprises an enclosure for shielding surrounding environment from operations performed on the workpiece via the functional head, the enclosure comprising a shroud extending beneath the functional head and defining an opening to align with the workspace.

6. The combination of claim 5 wherein the shroud is of a height-reducing configuration, the shroud having upper and lower portions in which the upper portion is configured to slide relative to the lower portion when the lower portion comes in contact with the table at the workspace when lowering the functional head toward the workpiece for the operations thereon.

7. The combination of claim 5 wherein the workspace is defined to extend no more than 2 feet from the outer enclosure.

8. The combination of claim 6 wherein the workspace is defined to extend no more than 1 foot from the outer enclosure.

9. The combination of claim 5 wherein the punch press further comprises a ram, a vertical axis of the functional head having a 0 foot offset in the y-direction and an offset of no more than 4 feet in the x-direction from a vertical axis of the ram.

10. The combination of claim 9 wherein the offset of the vertical axis of the functional head in the x-direction is no more than 3 feet from the vertical axis of the ram.

11. The combination of claim 5 wherein the functional head is a laser head, wherein the laser head comprises underlying elements sized for use of the laser head for etching and scribing operations on the workpiece.

12. The combination of claim 6 wherein the underlying elements of the laser head are comprised for generation of a fiber laser during the functional head operations on the workpiece.

13. The combination of claim 1 wherein the functional head is a laser head, wherein the laser head comprises underlying elements sized for use of the laser head for cutting operations on the workpiece.

14. The combination of claim 1 wherein the punch press is a turret press.

15. A complementary system for use with a punch press, the system adapted to perform one or more processes to enhance functionality of the punch press, the system comprising:
a functional assembly comprising a functional head, the functional head configured for performing a machining operation on a workpiece, the functional assembly configured for mounting to an outer enclosure of a punch press such that the assembly is positioned physically separate from an interior of the punch press and the functional head is limited to vertical movement relative to the outer enclosure;
wherein the functional assembly further comprises:
a slide assembly that supports the functional head, wherein movement of the slide assembly corresponds to the vertical movement of the functional head; and
a motor assembly configured to operably actuate the sliding assembly;
wherein the functional head, the slide assembly, and the motor assembly are in a vertically-stacked configuration so as to establish a tight profile with the press if mounted thereto, whereby the functional assembly extends no more than 2 feet from the outer enclosure.

16. The system of claim 15 wherein the slide assembly comprises a mounting configuration by which the functional assembly is mountable to the outer enclosure of the punch press.

17. The system of claim 15 wherein the system further comprises a station on which the functional assembly is mounted and by which the functional assembly is mountable to the outer enclosure of the punch press.

18. The system of claim 15 wherein the functional assembly further comprises an enclosure for shielding surrounding environment from operations performed via the functional head, the enclosure comprising a shroud extending beneath the functional head in concert with the vertically-stacked configuration.

19. The system of claim 18 wherein the functional head is a laser head, wherein the laser head comprises underlying elements sized for use of the laser head for etching and scribing operations.

20. The system of claim 19 wherein the underlying elements of the laser head are comprised for generation of a fiber laser during the functional head operations on the workpiece.

21. The system of claim 15 wherein the functional head is a laser head, wherein the laser head comprises underlying elements sized for use of the laser head for cutting operations.

22. A method for performing one or more operations per a machining work order via both a punch press and a complementary system thereof, the system enhancing functionality of the punch press, the method comprising the steps of:
providing a system comprising a functional assembly including a functional head, the functional head configured for performing a machining operation on a workpiece, the functional assembly being mounted to an outer enclosure of the press such that the functional head is positioned adjacent to an opening defined in the press outer enclosure;
inputting a workpiece machining job via a user console;
uploading corresponding operations for the job to a control module of the press;
performing the operations on a workpiece via the press and the system, one of the operations involving the system whereby the control module:
directs the workpiece to be positioned beneath the functional head; and
actuates the functional assembly for the one operation to be performed;
whereby the functional head is moved from a stored position to a working position for performing the one operation on the workpiece; and
the one operation is performed on the workpiece via the functional head in a workspace adjacent to the press enclosure opening.

23. The method of claim 22 wherein the punch press comprises a table for supporting and selectively moving the workpiece, whereby the control module directs the table to position the workpiece beneath the functional head in the workspace, the workspace extending no more than 2 feet from the outer enclosure.

24. The method of claim 22 wherein the punch press comprises a ram, wherein a vertical axis of the functional head has a 0 foot offset in the y-direction and an offset of no more than 3 feet in the x-direction from a down stroke axis of the ram.

25. The method of claim 22 wherein the functional head is a laser head, wherein the laser head comprises underlying elements for generation of a fiber laser during the functional head operations on the workpiece.

26. The method of claim 25 wherein the functional head is a laser head, wherein the underlying elements of the laser head are sized for use of the laser head for etching and scribing operations.

27. The method of claim 25 wherein the functional head is a laser head, wherein the underlying elements of the laser head are sized for use of the laser head for cutting operations.
